(19) United States
(12) Patent Application Publication
(10) Pub. No.: US 2004/0168194 A1
(43) Pub. Date: Aug. 26, 2004

(54) Internet tactical alarm communication system

(76) Inventor: John M. Hughes, Myrtle Beach, SC (US)

Correspondence Address: LITMAN LAW OFFICES, LTD., P.O. BOX 15035 CRYSTAL CITY STATION, ARLINGTON, VA, 22215, US

(21) Appl. No.: 10/329,481

(22) Filed: Dec. 27, 2002

(51) Int. Cl. H04N 7/173

(52) U.S. Cl. 725/105; 348/152

(57) ABSTRACT

An Internet tactical alarm communication (ITAC) system includes at least one sensor, at least one video camera, and an ITAC computer delivery unit, wherein the at least one sensor, the at least one video camera, and the ITAC computer delivery unit are communicatively interconnected, and the ITAC system provides real-time data regarding a particular condition.

### BACKGROUND OF THE INVENTION

1. Field of the Invention

The present invention relates generally to security systems and, more particularly, to an Internet tactical alarm communication (ITAC) system.

2. Description of the Related Art

Existing security systems typically operate by being activated by a remote sensor, zone alarm, “panic button”, smoke alarm, etc., and relaying that alarm to a central monitoring service or a 911 dispatch office. Monitoring personnel then notify the proper authorities that an alarm has been received without knowing the precise nature of the alarm. In the case of security systems using video surveillance, videotape recordings that are made at the scene have to be viewed some time after the actual event, offering no real time information to authorities during the incident. Law enforcement or property owners must respond to these alarms without any indication of what is occurring at the site. Essentially, current alarm and surveillance systems leave the responding parties completely deaf, dumb, and blind to the situation. Video surveillance services using delivery of data through Internet protocols rely on routing through central servers, third party monitoring stations, and are always on. This ‘always on’ status or constant stream of video requires excessive bandwidth, and also allows for unauthorized “BIG BROTHER” viewing of the video stream and potential hacking. No current security or video surveillance system delivers real time data directly to law enforcement, emergency personnel, or any other authorized agency. There is a need for a video surveillance system that is configured to detect an event (e.g., unauthorized entry, robbery, fire, or the like) in or around a property and provide real time data, such as live video, audio, and/or information regarding the event, directly to property owners and/or responsible law enforcement agencies through telecommunications and/or Internet protocols.

The related art is represented by the following references of interest.

U.S. patent application Publication No. 2001/0056579 A1, published on Dec. 27, 2001 for Haruo Kogane et al., describes a network surveillance video camera system. The Kogane et al. application does not suggest an ITAC system according to the claimed invention.

U.S. patent application Publication No. 2002/0005894 A1, published on Jan. 17, 2002 for Bruce A. Foodman et al., describes a system for detecting an event within a premises and providing data such as live or recorded video, audio or data regarding an event to a website. The Foodman et al. application does not suggest an ITAC system according to the claimed invention.

U.S. patent application Publication No. 2002/0030738 A1, published on Mar. 14, 2002 for Joseph D. Moreinis et al., describes a web based monitoring system and method for transmitting data captured by a camera to a computer, detecting an occurrence of an event based on the transmitted data, generating a notification upon occurrence of an event, and transmitting the notification to a user. The Moreinis et al. application does not suggest an ITAC system according to the claimed invention.

U.S. patent application Publication No. 2002/0054211 A1, published on May 9, 2002 for Steven D. Edelson et al., describes surveillance video camera systems enhanced by detecting object motion in the video to reduce overload on the operator's attention. The Edelson et al. application does not suggest an ITAC system according to the claimed invention.

U.S. patent application Publication No. 2002/0147982 A1, published on Oct. 10, 2002 for Surendra N. Naidoo et al., describes a video security system for the remote verification and monitoring of conditions surrounding an alarm signal. The Naidoo et al. application does not suggest an ITAC system according to the claimed invention.

U.S. Pat. No. 5,657,076, issued on Aug. 27, 1997 to Hollis M. Tapp, describes a security and surveillance system that generates an infrared coded signal for performing a specific function. The Tapp patent does not suggest an ITAC system according to the claimed invention.

U.S. Pat. No. 5,861,905, issued on Jan. 19, 1999 to Paul L. Brummett, describes an intelligent television system for producing high definition picture and sound images for broadcast, direct link, satellite and teleconferencing. The Brummett patent does not suggest an ITAC system according to the claimed invention.

U.S. Pat. No. 6,163,338, issued on Dec. 19, 2000 to Dan Johnson et al., describes an apparatus and method for providing a video or audio record of a predetermined activity close in time to a preselected triggering event. The Johnson et al. patent does not suggest an ITAC system according to the claimed invention.

U.S. Pat. No. 6,166,729 B1, issued on Dec. 26, 2000 to Edward Acosta et al., describes a remote viewing system for viewing digital images of remote locations. The Acosta et al. patent and application does not suggest an ITAC system according to the claimed invention.

U.S. Pat. No. 6,271,752 B1, issued on Aug. 7, 2001 to Christos I. Vaios, describes a multi-access remote system having a surveillance area, a plurality of end user locations, and a communications network such that one or more of the end user locations can establish a connection with the security surveillance area, and vice versa, using a communications protocol via the communications network. The Vaios patent does not suggest an ITAC system according to the claimed invention.

U.S. Pat. No. 6,400,264 B1, issued on Jun. 4, 2002 to Chi-Sheng Hseih, describes a community far end intelligent image monitoring system for remotely monitoring a predetermined local site. The Hseih patent does not suggest an ITAC system according to the claimed invention.

U.S. Pat. No. 6,400,265 B1, issued on Jun. 4, 2002 to Michael J. Saylor et al., describes a monitoring sytem for providing images where an alarm situation may be defected by comparing images. The Saylor et al. patent does not suggest an ITAC system according to the claimed invention.

U.S. Pat. No. 6,411,209 B1, issued on Jun. 25, 2002 to Damian M. Lyons et al., describes a security monitoring system. The Lyons et al. patent does not suggest an ITAC system according to the claimed invention.

U.S. Pat. No. 6,456,321 B1, issued on Sep. 24, 2002 to Fuji Ito et al., describes a surveillance camera apparatus in which video data is obtained by photographing a scene of a surveillance area with a surveillance camera. The Lyons et al. patent does not suggest an ITAC system according to the claimed invention.

U.S. Pat. No. 6,466,258 B1, issued on Oct. 15, 2002 to Bronislaw R. Mogenis et al., describes a method and apparatus for providing communication between premises and emergency personnel responding to an emergency at the premises. The Mogenis et al. patent does not suggest an ITAC system according to the claimed invention.

European Patent Application Publication No. 0 585 033 A1, published on Mar. 2, 1992, describes an image recording device. The European application does not suggest an ITAC system according to the claimed invention.

Japan Patent document 1-116898, published on May 9, 1989, describes an image recording device. The Japan '898 document does not suggest an ITAC system according to the claimed invention.

Japan Patent document 5-27673, published on Feb. 5, 1993, describes a guard system which can accurately send a turnout command to a patrol car and prevent a robbery. The Japan '673 document does not suggest an ITAC system according to the claimed invention.

None of the above inventions and patents, taken either singularly or in combination, is seen to describe the instant invention as claimed. Thus an ITAC system solving the aforementioned problems is desired.

### SUMMARY OF THE INVENTION

The present invention is an Internet tactical alarm communication (ITAC) system. The ITAC system includes at least one sensor, at least one video camera, and an ITAC computer delivery unit, wherein the at least one sensor, the at least one video camera, and the ITAC computer delivery unit are communicatively interconnected, and the ITAC system provides real time data regarding a particular condition.

Accordingly, it is a principal aspect of the invention to provide an ITAC system including at least one sensor, at least one video camera, and an ITAC computer delivery unit, wherein the at least one sensor, the at least one video camera, and the ITAC computer delivery unit are communicatively interconnected, and the ITAC system provides real time data regarding a particular condition.

It is another aspect of the present invention to provide an ITAC system including at least one sensor, at least one video camera, and an ITAC computer delivery unit including a monitor, a memory storage device, and a remotely activated computer interface (RACI) device, wherein the RACI device includes at least one processor and is communicatively interconnected with the monitor and the memory storage device, and the memory storage device includes stored therein computer useable program code, the computer useable program code including first instruction means for securely activating the ITAC computer delivery unit, associated video cameras, and associated sensors; second instruction means for continuously recording and storing imagery data from each associated video camera for a predetermined period of time in buffer memory means; third instruction mean for receiving and monitoring a signal from a sensor regarding a particular parameter; fourth instruction means for processing the received sensor signal and determining whether the processed sensor signal represents an undesirable parameter condition; fifth instruction means for placing the ITAC system in a tactical mode, stopping the continuous recording of imagery data in the buffer memory means during time when the parameter condition associated with the processed sensor signal remains undesirable, recording and storing imagery data from video cameras associated with the processed sensor signal on predetermined memory storage means; sixth instruction means for alerting authorized users that alert authorized users the processed sensor signal represents un undesirable parameter condition so they may remotely access ITAC system resources; seventh instruction means for communicatively providing imagery data regarding associated video cameras if the processed sensor signal represents an undesirable condition to authorized users; eighth instruction means for placing the ITAC system in a non-tactical mode when the processed sensor signal represents a desirable condition, initiating continuous recording of imagery data in the buffer memory means while the ITAC system remains in a non-tactical mode, and ninth instruction means for securely deactivating the ITAC computer delivery unit by an authorized operator of the ITAC computer delivery unit.

Still another aspect of the present invention to provide an ITAC method that securely activates an ITAC computer delivery unit, associated video cameras, and associated sensors; continuously records and stores imagery data from each associated video camera for a predetermined period of time in buffer memory means; receives and monitors a signal from a sensor regarding a particular parameter; processes the received sensor signal and determining whether the processed sensor signal represents an undesirable parameter condition; places the ITAC system in a tactical mode, stops the continuous recording of imagery data in the buffer memory means during time when the parameter condition associated with the processed sensor signal remains undesirable, and records and stores imagery data from video cameras associated with the processed sensor signal on predetermined memory storage means; alerts authorized users that alert authorized users the processed sensor signal represents un undesirable parameter condition so they may remotely access ITAC system resources; communicatively provides imagery data regarding associated video cameras if the processed sensor signal represents an undesirable condition to authorized users; places the ITAC system in a non-tactical mode when the processed sensor signal represents a desirable condition, initiating continuous recording of imagery data in the buffer memory means while the ITAC system remains in a non-tactical mode securely deactivates the ITAC computer delivery unit by an authorized user of the ITAC computer delivery unit.

It is an aspect of the invention to provide improved elements and arrangements thereof in an ITAC system for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental view of a bank being robbed by robbers, where the bank is equipped with an ITAC system according to the present invention.

FIG. 2 is a block diagram of a part of an ITAC system according to the present invention.

FIG. 3 is a block diagram of a part of an ITAC system according to the present invention.

Fig. 4 is a block diagram of a part of an ITAC system according to the present invention.

FIG. 5 is a circuit diagram of RACI circuitry according to the present invention.

FIG. 6 is a circuit diagram of a RACI switch connector interface according to the present invention.

Similar reference characters denote corresponding features consistently throughout the attached drawings.

### DETAILED DESCRIPTION OF THE PREFERRED EMBODIMENTS

The present invention is an ITAC system. The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

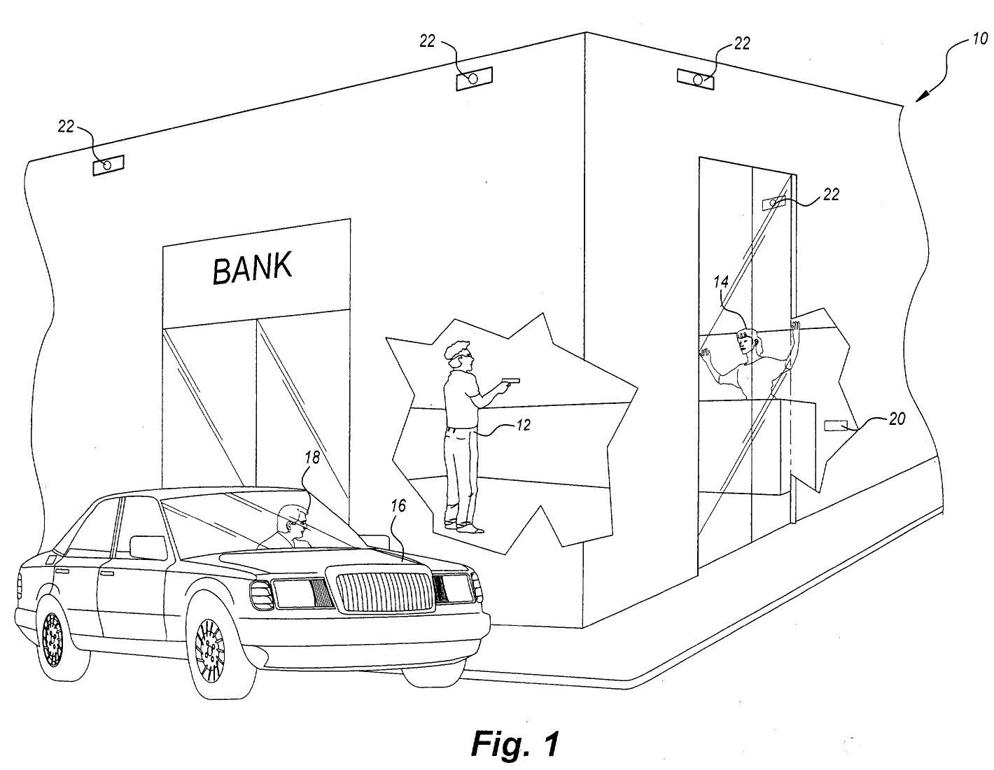

Referring to the drawings, FIG. 1 shows a bank 10 being robbed by a robber 12 with an accomplice 18 waiting outside in a car 16. The bank 10 includes an employee 14 and is equipped with an ITAC system according to the invention. The ITAC system is an event driven system that provides real-time imagery data that may be recorded and/or provided to remote authorized users, such as property owners, law enforcement personnel, or the like. The ITAC system has been previously activated by an authorized user who has entered an activation code to the ITAC system, such as a personal identification number, a password, or the like. The ITAC system includes an ITAC computer delivery unit 20, sensor means for monitoring a predetermined parameter (not shown), and video camera means 22 for providing imagery data. Once any sensor detects an undesirable parameter condition, the ITAC system becomes tactically active. When the ITAC system is tactically active, the ITAC system records imagery data from video cameras 22 associated near and/or remote to the undesirable parameter condition, and may provide imagery data (e.g, video, audio, informational, etc.) to remote authorized users during the period of time that the ITAC system is in a tactical mode (i.e, during the period of time that the parameter condition remains undesirable.

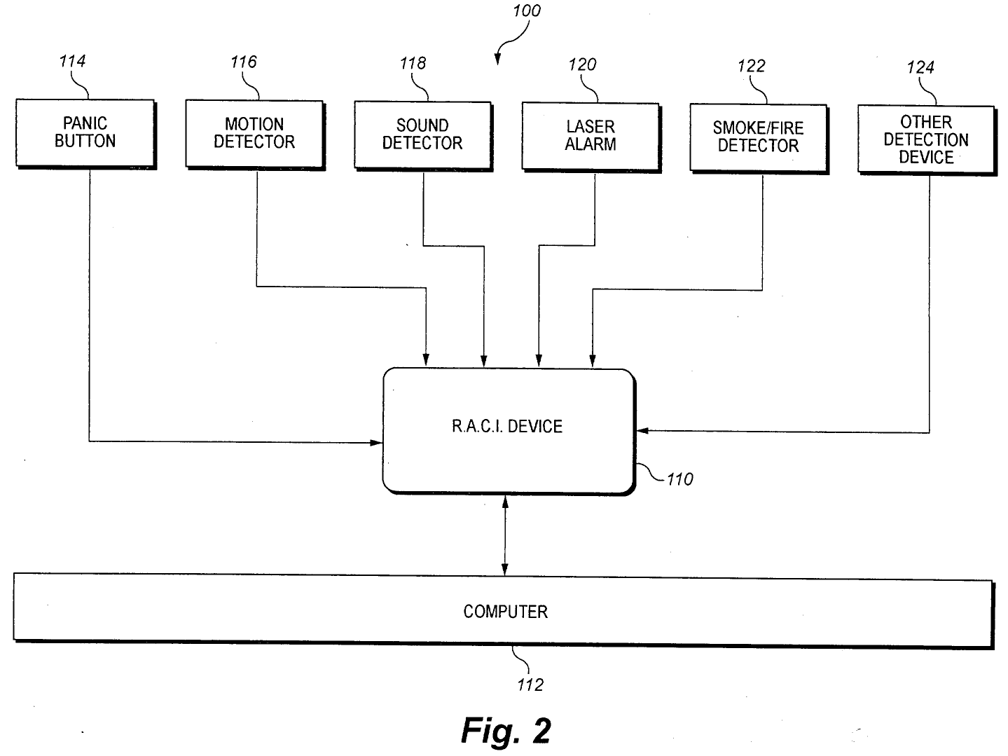

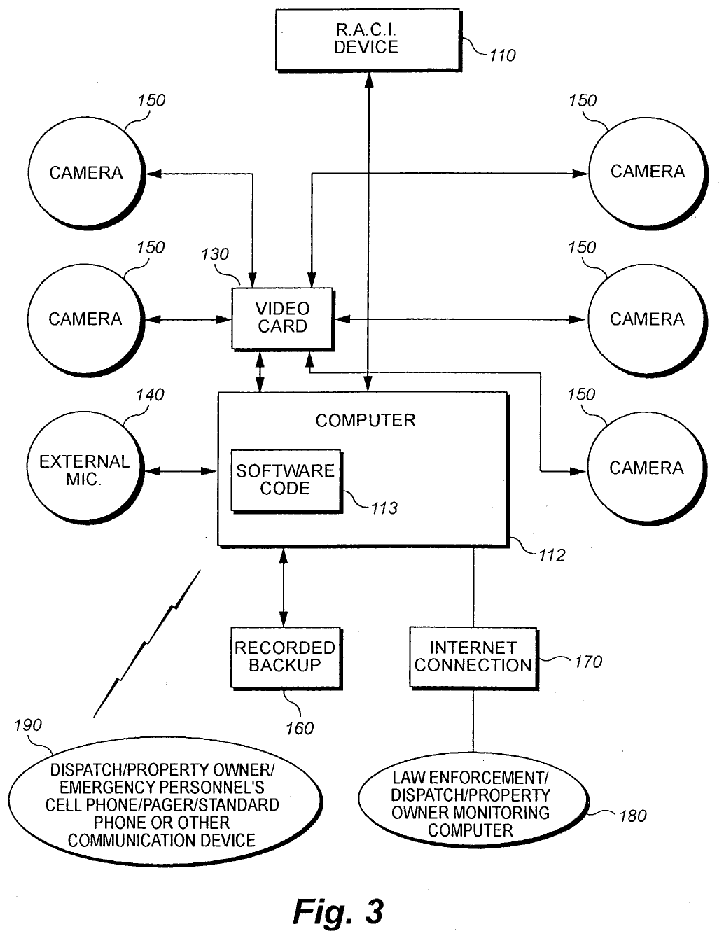

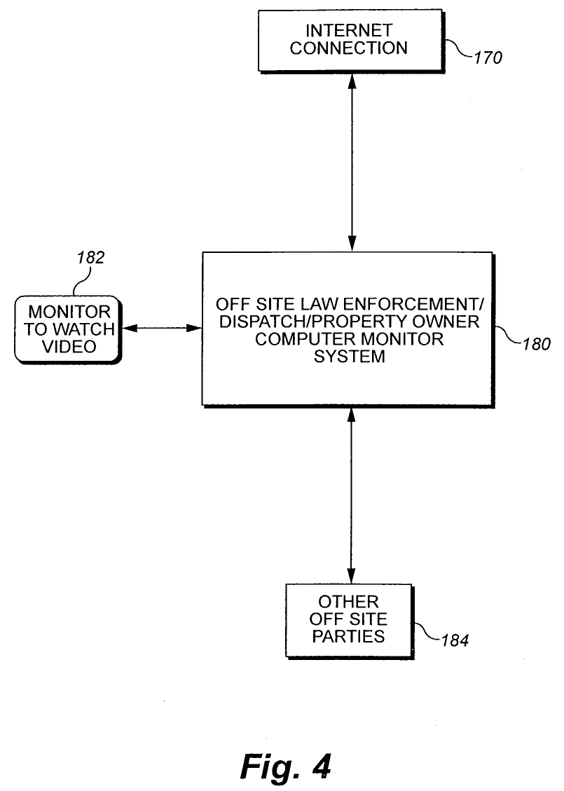

FIGS. 2-6 more particularly illustrate one example of an ITAC system 100. The ITAC system 100 includes at least one sensor means 114, 116, 118, 120, 122, 124, at least one video camera means 150, and an ITAC computer delivery unit 112. The sensor means 114, 116, 118, 120, 122, 124, video camera means 150, and ITAC computer delivery unit 112 are communicatively interconnected.

The sensor means 114, 116, 118, 120, 122, 124 may be any type of sensor for monitoring a particular parameter, such as an intrusion, a movement, a fire, or the like. As shown, the sensor means may include a panic button 114, a motion detector 116, a sound detector 118, a laser alarm 120, a smoke/fire detector 122, or any other detection device 124. The sensor means 114, 116, 118, 120, 122, 124 may communicate with the ITAC computer delivery unit by any known protocol standard. The video camera means 150 may be any type of visual recording device, such as a digital video recorder or the like.

The ITAC computer delivery unit 112 is illustrated with a memory storage device 113 having contained therein software code. The ITAC system 100 may also include an external microphone 140 to enable a user to verbally activate and/or deactivate the ITAC system 100 with any known voice recognition technique, and/or to communicate with individuals remote from the ITAC system 100 when the ITAC system is in a tactical mode. The ITAC computer delivery unit 112 is communicatively interconnected with a video card 130 which is configured to receive imagery data (e.g., video, audio, and/or informational data). The ITAC computer delivery unit 112 is also communicatively interconnected with a recorded backup unit 160 which may be configured to continuously record and maintain a predetermined amount of time, such as fifteen minutes or the like, of recorded imagery data from cameras 150 in a buffer memory. The ITAC computer delivery unit 112 is also communicatively interconnected with an Internet connection 170. The Internet connection 170, e.g., a modem or the like, enables the ITAC system 100 to provide real-time imagery data of the protected premises over the Internet to off site authorized users 180, e.g., off site law enforcement personnel, dispatch personnel, property owner(s) , computer monitor system personnel, or the like. The ITAC computer delivery unit 112 may also be communicatively interconnected, wirelessly and/or non-wirelessly, with remote authorized users 190, e.g., dispatch personnel, property owner(s), cell phones, pagers, standard phones, or the like.

The ITAC system 100 includes a monitor means for providing imagery data, a memory storage means for recording imagery data, and a remotely activated computer interface (RACI) device. The monitor means may be any monitor according to the desires of the user, such as a liquid crystal display, a cathode ray tube monitor, a plasma monitor, a flat screen monitor, or the like. The memory storage means may be any memory storage means according to the desires of the user, such as Flash memory, optical memory, magnetic media memory, or the like. The RACI device includes at least one processor and is communicatively interconnected with the monitor means and the memory storage means. Computer useable program code may be stored and/or transferred to the memory storage means of the RACI device. The computer useable program code means is read and processed by the RACI processor(s), and causes the ITAC computer delivery unit to perform programmed functions. Movement and process of instructions as well as data is controlled and accomplished by the RACI processor(s).

The RACI processor(s) may execute various programs under the control of the operating system of ITAC computer delivery unit. For example, any computer useable software code stored in the memory storage device of the RACI device may include: first instruction means for securely activating the ITAC computer delivery unit, associated video cameras, and associated sensors; second instruction means for continuously recording and storing imagery data from each associated video camera for a predetermined period of time in buffer memory means; second instruction mean for receiving and monitoring a signal from a sensor regarding a particular parameter; third instruction means for processing the received sensor signal and determining whether the processed sensor signal represents an undesirable parameter condition; fourth instruction means for placing the ITAC system in a tactical mode, stopping the continuous recording of imagery data in the buffer memory means during time when the parameter condition associated with the processed sensor signal remains undesirable, recording and storing imagery data from video cameras associated with the processed sensor signal on predetermined memory storage means; fifth instruction means for alerting authorized users that alert authorized users the processed sensor signal represents un undesirable parameter condition so they may remotely access ITAC system resources; sixth instruction means for communicatively providing imagery data regarding associated video cameras if the processed sensor signal represents an undesirable condition to authorized users; seventh instruction means for placing the ITAC system in a non-tactical mode when the processed sensor signal represents a desirable condition, initiating continuous recording of imagery data in the buffer memory means while the ITAC system remains in a non-tactical mode; and eigthth instruction means for securely deactivating the ITAC computer delivery unit by an authorized operator of the ITAC computer delivery unit.

The ITAC computer delivery unit is configured to enable direct transfer of data between authorized users. Data transfer occurs using any Internet protocol according to the desires of the user, such as broadband bi-directional cable connection, digital subscriber line, wireless phone service, satellite system delivery, Bluetooth, standard phone line, or the like. The ITAC system provides a direct audio/visual link to authorized users, such as law enforcement personnel, property owners, or the like, to instantly alert and provide instant and direct real-time audio/visual/informational inspection of a protected premises. The ITAC system does not rely on a third party to receive, interpret and re-deliver alarm notifications, except as desired according to authorized users.

An ITAC method for providing video surveillance to a premises securely activates an ITAC computer delivery unit, associated video cameras, and associated sensors. The ITAC method then continuously records and stores imagery data from each associated video camera for a predetermined period of time in buffer memory means, receives and monitors a signal from a sensor regarding a particular parameter, processes the received sensor signal and determines whether the processed sensor signal represents an undesirable parameter condition. The ITAC method then places the ITAC system in a tactical mode, stops the continuous recording of imagery data in the buffer memory means during time when the parameter condition associated with the processed sensor signal remains undesirable, records and stores imagery data from video cameras associated with the processed sensor signal on predetermined memory storage means, and alerts authorized users that the processed sensor signal represents un undesirable parameter condition so they may remotely access ITAC system resources. The ITAC method also communicatively provides imagery data regarding associated video cameras if the processed sensor signal represents an undesirable condition to authorized users, and then places the ITAC system in a non-tactical mode when the processed sensor signal represents a desirable condition, and initiates continuous recording of imagery data in the buffer memory means while the ITAC system remains in a non-tactical mode. The ITAC method may also securely deactivate the ITAC computer delivery unit by an authorized operator of the ITAC computer delivery unit.

The ITAC system eliminates any need for a central monitoring station by directly transferring data between authorized users, and eliminates any need for a shared server or proprietary web site to display video or other data. The data transfer may occur by any known Internet compliant protocol, such as through a broadband bi-directional cable connection, a digital subscriber line, a wireless phone service, satellite system delivery, Bluetooth, a standard phone line, or the like. While the ITAC system is event driven, a predetermined amount of time, such as fifteen minutes or the like, of imagery data may be continuously buffered (recorded) by the ITAC system to ensure a seamless documentation of events.

Since the ITAC system becomes tactically active when a processed sensor signal represents un undesirable parameter condition or an when on-site “panic button” is manually activated by an authorized user at the protected premises, potential for system failure due to continuous data transfer is greatly reduced, and unauthorized parties are precluded from accessing the protected premises to view real-time images or communications. The ITAC system may also be configured to alert authorized users via email that a processed sensor signal represents an undesirable parameter condition so they may remotely access system resources (video cameras, sensor data, or the like).

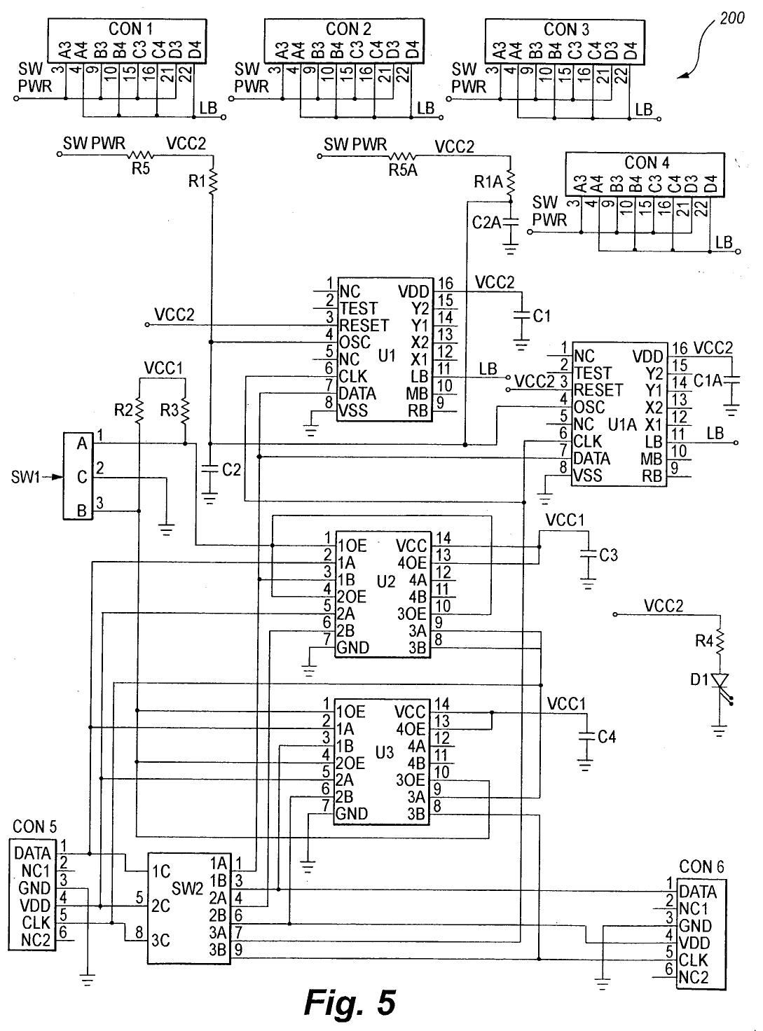

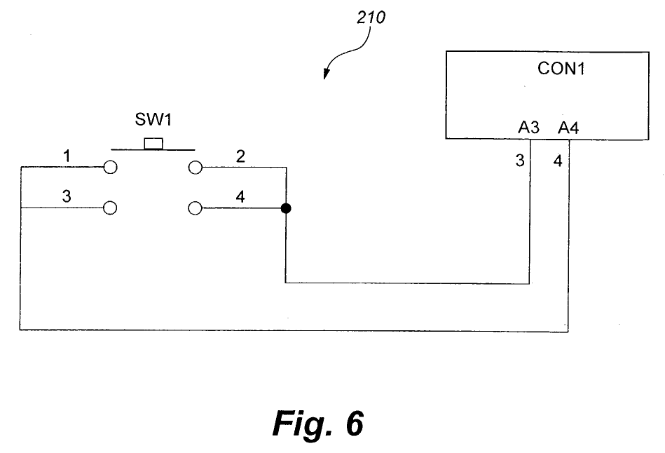

A circuit diagram of an example of RACI circuitry 200 is shown in FIGS. 5 and 6. The circuit elements are preferably, but not limited to:

| Component | Part Number or rating |
|---|---|
| R1 | 120 kΩ (120KQBK-NO) |
| R2 | 10 kΩ (10KQBK-NO) |
| R3 | 10 kΩ (10KQBK-NO) |
| R4 | 1.6 kΩ (1.6KQBK-NO) |
| R5 | 1.8 kΩ (1.8KQBK-NO) |
| R5A | 1.8 kΩ (1.8KQBK-NO) |
| C1 | 0.1 μf (0.1pF/P4923-NO) |
| C1A | 0.1 μf (0.1uF/P4923-NO) |
| C2 | 1000 pf (1000pF/P4923-NO) |
| C2A | 1000 pf (1000pF/P4923-NO) |
| C3 | 0.1 μf (0.1uF/P4923-NO) |
| C4 | 0.1 μf (0.1uF/P4923-NO) |
| D1 | GREEN/MV2454-NO diode |
| U1 | HT6523 processor |
| U1A | HT6523 processor |
| U2 | SN74CBT3125DR processor |
| U3 | SN74CBT3125DR processor |
| CON1 | H9055-ND connector |
| CON2 | H9055-ND connector |
| CON3 | H9055-ND connector |
| CON4 | H9055-ND connector |
| CON5 | CP-2450-ND connector |
| CON6 | CP-2460-ND connector |
| SW1 | CKN1253-ND switch |
| SW2 | CKN121-ND switch |

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. An Internet tactical alarm communication (ITAC) system comprising:
at least one sensor means for monitoring a predetermined parameter;
at least one video camera means recording imagery data; and
an ITAC computer delivery unit,
wherein said at least one sensor means, said at least one video camera means, and said ITAC computer delivery unit are communicatively interconnected, and said ITAC system provides real-time data regarding a particular condition.

2. The ITAC system according to claim 1, wherein said at least one video camera means is a digital video recorder.

3. The ITAC system according to claim 1, wherein said ITAC computer delivery unit comprises:
a monitor means for providing imagery data;
a memory storage means for storing imagery data; and
a remotely activated computer interface (RACI) device,
wherein said RACI device includes at least one processor and is communicatively interconnected with said monitor and said memory storage device.

4. The ITAC system according to claim 3, wherein said monitor means is a flat screen display.

5. The ITAC system according to claim 3, wherein said memory storage device includes stored therein computer useable program code, said computer useable program code comprising:
first instruction means for securely activating the ITAC computer delivery unit, associated video cameras, and associated sensors;
second instruction means for continuously recording and storing imagery data from each associated video camera for a predetermined period of time in buffer memory means;
third instruction mean for receiving and monitoring a signal from a sensor regarding a particular parameter; fourth instruction means for processing the received sensor signal and determining whether the processed sensor signal represents an undesirable parameter condition;
fifth instruction means for placing the ITAC system in a tactical mode, stopping the continuous recording of imagery data in the buffer memory means during time when the parameter condition associated with the processed sensor signal remains undesirable, recording and storing imagery data from video cameras associated with the processed sensor signal on predetermined memory storage means;
sixth instruction means for alerting authorized users that alert authorized users the processed sensor signal represents un undesirable parameter condition so they may remotely access ITAC system resources;
seventh instruction means for communicatively providing imagery data regarding associated video cameras if the processed sensor signal represents an undesirable condition to authorized users; and
eighth instruction means for placing the ITAC system in a non-tactical mode when the processed sensor signal represents a desirable condition, initiating continuous recording of imagery data in the buffer memory means while the ITAC system remains in a non-tactical mode.

6. The ITAC system according to claim 5, wherein said computer useable program code further comprises ninth instruction means for securely deactivating the ITAC computer delivery unit by an authorized operator of the ITAC computer delivery unit.

7. An Internet tactical alarm communication (ITAC) method comprising:
securely activating an ITAC computer delivery unit, associated video cameras, and associated sensors;
continuously recording and storing imagery data from each associated video camera for a predetermined period of time in buffer memory means;
receiving and monitoring a signal from a sensor regarding a particular parameter;
processing the received sensor signal and determining whether the processed sensor signal represents an undesirable parameter condition;
placing the ITAC system in a tactical mode, stopping the continuous recording of imagery data in the buffer memory means during time when the parameter condition associated with the processed sensor signal remains undesirable, and recording and storing imagery data from video cameras associated with the processed sensor signal on predetermined memory storage means;
alerting authorized users that alert authorized users the processed sensor signal represents un undesirable parameter condition so they may remotely access ITAC system resources;
communicatively providing imagery data regarding associated video cameras if the processed sensor signal represents an undesirable condition to authorized users; and
placing the ITAC system in a non-tactical mode when the processed sensor signal represents a desirable condition, initiating continuous recording of imagery data in the buffer memory means while the ITAC system remains in a non-tactical mode.

8. The ITAC method according to claim 8, further comprising securely deactivating the ITAC computer delivery unit by an authorized user of the ITAC computer delivery unit.
